(19) United States
(12) Patent Application Publication
(10) Pub. No.: US 2021/0341737 A1
(43) Pub. Date: Nov. 4, 2021

(54) DISPLAY CONTROL DEVICE, DISPLAY CONTROL METHOD, AND NON-TRANSITORY TANGIBLE COMPUTER-READABLE MEDIUM THEREFOR

(71) Applicant: DENSO CORPORATION, Kariya-city (JP)

(72) Inventors: Satoshi HORIHATA, Kariya-city (JP); Yusuke KONDO, Kariya-city (JP)

(21) Appl. No.: 17/374,374

(22) Filed: Jul. 13, 2021

Related U.S. Application Data
(63) Continuation of application No. PCT/JP2020/000813, filed on Jan. 14, 2020.

(30) Foreign Application Priority Data
Feb. 5, 2019 (JP) 2019-018881

(51) Int. Cl. G02B 27/01; G06K 9/00

(52) U.S. Cl. CPC G02B 27/0101; G08G 1/048; G02B 2027/0196; G06K 9/00671

(57) ABSTRACT

A virtual image is superimposed on a foreground scenery of an occupant. It is determined whether a road condition, for associating a display position of the virtual image with a position of an object in the foreground scenery with respect to a road on which the vehicle travels, is satisfied. The virtual image is generated as a superposing virtual image that presents information by associating the display position with the position of the object when the road condition is satisfied. At least a part of the virtual image is generated as a non-superimposing virtual image that presents the information without associating the display position with the position of the object when the road condition is not satisfied.

### CROSS REFERENCE TO RELATED APPLICATION

The present application is a continuation application of International Patent Application No. PCT/JP2020/000813 filed on Jan. 14, 2020, which designated the U.S. and claims the benefit of priority from Japanese Patent Application No. 2019-018881 filed on Feb. 5, 2019. The entire disclosures of all of the above applications are incorporated herein by reference.

### TECHNICAL FIELD

The present disclosure relates to a display control device and a display control method for controlling a display of a virtual image, and a non-transitory tangible computer-readable medium therefor.

### BACKGROUND

Conventionally, according to a conceivable technique, a device that projects display light onto the windshield of a vehicle to display a virtual image on an occupant has been disclosed. This device in the conceivable technique displays the travelling road shape in front of the vehicle as a virtual image based on the current position of the vehicle and the map information.

### SUMMARY

According to an example embodiment, a virtual image is superimposed on a foreground scenery of an occupant. It is determined whether a road condition, for associating a display position of the virtual image with a position of an object in the foreground scenery with respect to a road on which the vehicle travels, is satisfied. The virtual image is generated as a superposing virtual image that presents information by associating the display position with the position of the object when the road condition is satisfied. At least a part of the virtual image is generated as a non-superimposing virtual image that presents the information without associating the display position with the position of the object when the road condition is not satisfied.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic view of a vehicle system including an HCU according to the first embodiment;

FIG. 2 is a diagram showing an example in which an HUD is mounted on a vehicle;

FIG. 3 is a block diagram showing a schematic configuration of an HCU;

FIG. 4 is a diagram showing an example of AR display;

FIG. 5 is a diagram showing an example of non-AR display;

FIG. 6 is a diagram showing a state of display deviation due to AR display of a comparative example; and

FIG. 7 is a flowchart showing an example of a process executed by the HCU.

### DETAILED DESCRIPTION

It is considered to present information in which the display position of the virtual image is associated with the position of the object by superimposing and displaying the virtual image on a specific object in the foreground by using a device in a conceivable technique. However, under the condition of the road on which the vehicle travels, the display position of the virtual image may shift with respect to the object, and the display position of the virtual image may not be correctly associated with the position of the object. In this case, the information presented by the virtual image may be erroneously recognized by the occupant.

In view of the above point, a display control device, a display control method, and a non-transitory tangible computer readable storage medium are provided for suppressing misrecognition of information presented by a virtual image.

One of the disclosed display control devices is a display control device used in a vehicle to control the display of a virtual image superimposed on the foreground of an occupant, and the display control device includes: a road condition determination unit that determines whether a road condition of a road on which the vehicle travels is satisfied for associating a display position of a virtual image with the position of the object in the foreground of the occupant; and a display image generation unit that generates the virtual image as a superimposing virtual image for presenting the information by associating the display position with the position of an object when the road condition is satisfied, and generates the virtual image as a non-superimposing virtual image for presenting the information without associating the display position of at least a part of the virtual image with the position of the object when the road condition is not satisfied.

One of the disclosed display control methods is a display control method used in a vehicle to control the display of a virtual image superimposed on the foreground of an occupant, and the program causes at least one processor to function as a road condition determination unit that determines whether a road condition of a road on which the vehicle travels is satisfied for associating a display position of a virtual image with the position of the object in the foreground of the occupant; and a display image generation unit that generates the virtual image as a superimposing virtual image for presenting the information by associating the display position with the position of an object when the road condition is satisfied, and generates the virtual image as a non-superimposing virtual image for presenting the information without associating the display position of at least a part of the virtual image with the position of the object when the road condition is not satisfied.

One of the disclosed non-transitory tangible computer-readable storage media includes instructions performed by the computer, and the instructions are used in the vehicle to control the display of a virtual image superimposed on the foreground of an occupant, and the instructions include: determining whether a road condition of a road on which the vehicle travels is satisfied for associating a display position of a virtual image with the position of the object in the foreground of the occupant; generating the virtual image as a superimposing virtual image for presenting the information by associating the display position with the position of an object when the road condition is satisfied; and generating the virtual image as a non-superimposing virtual image for presenting the information without associating the display position of at least a part of the virtual image with the position of the object when the road condition is not satisfied.

According to these disclosures, a non-superimposing virtual image is generated when it is not possible to relate the display position of the superposing virtual image to the position of the object in the foreground. Since the non-superimposing virtual image presents information without associating the display position with the position of the object in the foreground, the occupant can recognize the same information regardless of the display position. As described above, it is possible to provide a display control device and a display control program capable of suppressing erroneous recognition of information presented by a virtual image.

### First Embodiment

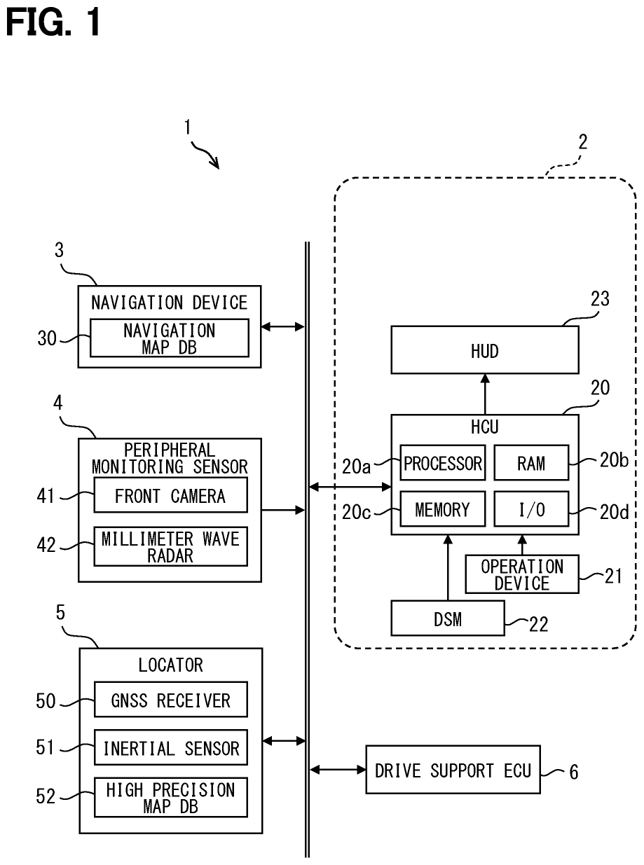

A display control device according to a first embodiment will be described with reference to FIGS. 1 to 7. The vehicle system 1 is used in a vehicle A traveling on a road such as an automobile. As an example, the vehicle system 1 includes an HMI (Human Machine Interface) system 2, a locator 5, a peripheral monitoring sensor 4, a driving support ECU 6, and a navigation device 3, as shown in FIG. 1. The HMI system 2, the navigation device 3, the peripheral monitoring sensor 4, the locator 5, the drive support ECU 6, and the navigation device 7 are connected to, for example, an in-vehicle LAN.

The navigation device 3 includes a navigation map database (hereinafter, navigation map DB) 30 that stores navigation map data. The navigation device 3 searches for a route that satisfies conditions such as time priority and distance priority to the set destination, and provides route guidance according to the searched route. The navigation device 3 outputs the searched route as scheduled route information to the in-vehicle LAN.

The navigation map DB 30 is a non-volatile memory and stores navigation map data such as link data, node data, and road shape. Navigation map data is maintained in a relatively wider area than high-precision map data. The link data includes various data such as a link ID that identifies the link, a link length that indicates the length of the link, a link direction, a link travel time, node coordinates between the start and end of the link, and road attributes. The node data includes a various pieces of data such as a node ID in which a unique number is assigned to each node on a map, node coordinates, a node name, a node type, a connection link ID in which a link ID of a link connected to the node is described, an intersection type, and the like. The navigation map data has node coordinates as two-dimensional position coordinate information represented by longitude coordinates and latitude coordinates.

As shown in FIG. 1, the locator 5 includes a GNSS (Global Navigation Satellite System) receiver 50, an inertial sensor 51, and a high-precision map database (hereinafter, high-precision map DB) 52. The GNSS receiver 50 receives positioning signals from multiple artificial satellites. The inertial sensor 51 includes a gyro sensor and an acceleration sensor, for example. The locator 5 sequentially measures a vehicle position of a subject vehicle A by combining the positioning signals received by the GNSS receiver 50 and the measurement results of the inertial sensor 51.

The locator 5 may use the travelling distance and the like obtained from the detection results sequentially output from the vehicle speed sensor mounted on the own vehicle for positioning the position of the own vehicle. Further, the locator 5 may specify the vehicle position of the own vehicle by using the high-precision map data described later and the detection result by the peripheral monitoring sensor 4 such as LIDAR that detects the point group of the feature points of the road shape and the structure. The locator 5 outputs the calculated vehicle position as own vehicle position information to the in-vehicle LAN.

The high-precision map DB 52 is a non-volatile memory and stores high-precision map data (i.e., high-precision map information). The high-precision map data includes information on roads, information on white lines and road markings, information on structures, and the like. the information about roads includes shape information such as position information for each point, curve curvature and slope, and connection relationship with other roads. The information on white lane markings and road markings includes, for example, type information of white lane markings and road markings, location information, and shape information. The information about the structure includes, for example, type information, position information, and shape information of each structure. Here, the structures are road signs, traffic lights, street lights, tunnels, overpasses, buildings facing roads, and the like. The high-precision map data is a three-dimensional map that includes altitude in addition to latitude and longitude with respect to position information.

The peripheral monitoring sensor 4 is an autonomous sensor mounted on the vehicle A to monitor the surrounding environment of the vehicle A. The peripheral monitoring sensor 4 detects objects around the vehicle such as moving dynamic targets such as pedestrians, animals other than humans, vehicles other than the own vehicle, and road markings such as falling objects, guardrails, curbs, traveling lane markings, and stationary static targets such as trees and the like.

For example, the peripheral monitor sensor 4 includes a front camera 41 that captures a predetermined range in front of the vehicle and around the subject vehicle, and a millimeter wave radar 42 that transmits a scanning wave to a predetermined range around the subject vehicle, and a scanning wave sensor such as a sonar and a lidar. The front camera 41 sequentially outputs the captured images to be sequentially captured as sensing information to the in-vehicle LAN. The scanning wave sensor sequentially outputs to the in-vehicle LAN as sensing information, the scanning result based on the received signal obtained when the reflected wave reflected by the object is received. The peripheral monitoring sensor 4 of the first embodiment includes at least a front camera 41 whose imaging range is a predetermined range in front of the own vehicle. The front camera 41 is arranged, for example, on the rearview mirror of the own vehicle, the upper surface of the instrument panel, or the like.

The driving support ECU 6 executes an automatic driving function that substitutes the driving operation by the occupant. The driving support ECU 6 recognizes the driving environment of the own vehicle based on the vehicle position and map data of the own vehicle acquired from the locator 5 and the sensing information by the peripheral monitoring sensor 4.

As an example of the autonomous driving function executed by the drive support ECU 6, the function includes an ACC (Adaptive Cruise Control) function that controls the traveling speed of the own vehicle so as to maintain the target inter-vehicle distance from the preceding vehicle by adjusting the driving force and the braking force. In addition, the function includes an AEB (Autonomous Emergency Braking) function that forcibly decelerates the own vehicle by generating a braking force based on the sensing information of a front situation of the vehicle The driving support ECU 6 may have other functions as a function of autonomous driving.

The HMI system 2 includes an operation device 21, a DSM 22, a head-up display (hereinafter referred to as HUD) 23, and an HCU (Human Machine Interface Control Unit) 20. The HMI system 2 accepts an input operation from an occupant who is a user of the own vehicle, and presents information to the occupant of the own vehicle. The operation device 21 is a group of switches operated by the occupants of the own vehicle. The operation device 21 is used to perform various settings. For example, the operation device 21 may be configured by a steering switch or the like arranged in a spoke portion of a steering wheel of the host vehicle.

The DSM 22 has a near-infrared light source, a near-infrared camera, and an image analysis unit. The DSM 22 is arranged, for example, to an upper surface of an instrument panel 12, with facing the near infrared camera toward the driver's seat. The DSM 22 captures the periphery of the driver's face or an upper body irradiated with near-infrared light by a near-infrared light source with a near-infrared camera, and captures a face image including the driver's face. The DSM 22 analyzes the captured face image by the image analysis unit and detects the viewpoint position of the driver. The DSM 22 detects the viewpoint position as, for example, three-dimensional position information. The DSM 22 sequentially outputs the detected viewpoint position information to the HCU 20.

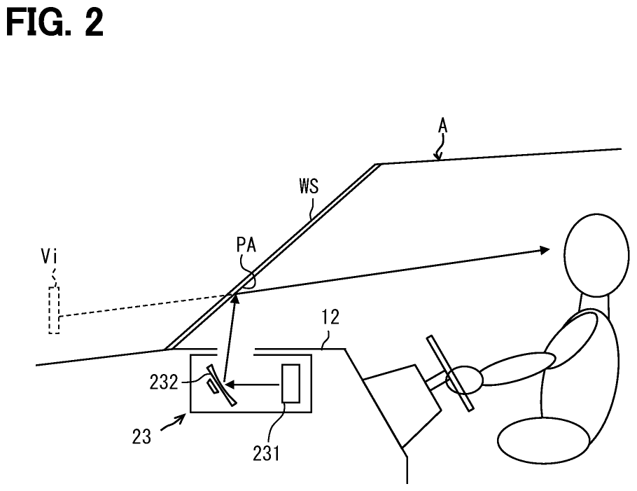

As shown in FIG. 2, the HUD 23 is arranged on an instrument panel 12 of the host vehicle. The HUD 23 forms a display image based on the image data output from the HCU 20 using, for example, a liquid crystal type or scanning type projector 231.

The HUD 23 projects the display image formed by the projector 231 onto the projection region PA defined by the front windshield WS as a projection member through an optical system 232 such as a concave mirror. The projection area PA is located in front of the driver's seat. A light beam of the display image reflected by the front windshield WS to an inside of a vehicle compartment is perceived by the passenger seated in the driver's seat. In addition, a light beam from the front scenery as a foreground landscape existing in front of the host vehicle, which has passed through the front windshield WS made of light transparent glass, is also perceived by the passenger seated in the driver's seat. As a result, the occupant can visually recognize the virtual image Vi of the display image formed in front of the front windshield WS by superimposing it on a part of the foreground scenery.

As described above, the HUD 23 superimposes and displays the virtual image Vi on the foreground of the vehicle A. The HUD 23 superimposes the virtual image Vi on a specific superimposing object in the foreground to realize a so-called AR (Augmented Reality) display.

In addition, the HUD 23 realizes a non-AR display in which the virtual image Vi is not superposed on a specific superimposing target but is simply superposed on the foreground. The projection member on which the HUD 23 projects the display image may not be limited to the front windshield WS, and may be a translucent combiner.

The HCU 20 mainly includes a microcomputer including a processor 20a, a RAM 20b, a memory device 20c, an I/O 20d, and a bus for connecting them, and is connected to the HUD 23 and an in-vehicle LAN. The HCU 20 controls the display by the HUD 23 by executing the display control program stored in the memory device 20c. The HCU 20 is an example of a display control device, and the processor 20a is an example of a processing unit. The memory device 20c is a non-transitory tangible storage medium that non-temporarily stores computer-readable program and data. The non-transitory tangible storage medium may be provided by a semiconductor memory or a magnetic disk.

The HCU 20 generates an image of the content to be displayed as a virtual image Vi on the HUD 23 and outputs the image to the HUD 23. As an example of the virtual image Vi, the HCU 20 generates a route guidance image that presents guidance information of the planned travel route of the vehicle A to the occupant. The HCU 20 generates a route guidance image especially at a point where a right or left turn is required such as an intersection or a point where a lane change is required.

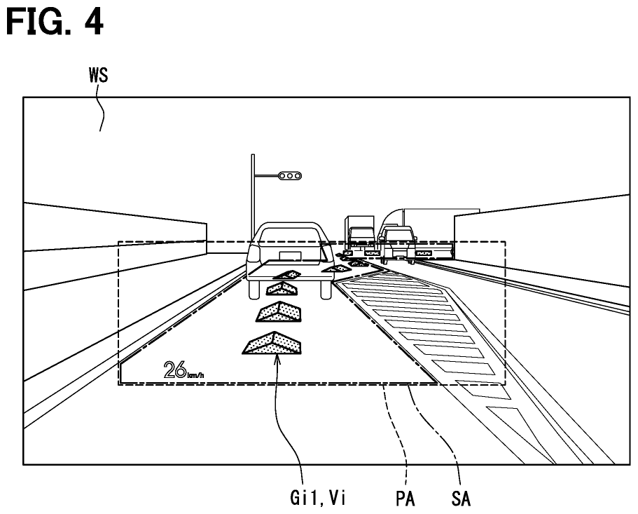

The HCU 20 selectively displays the route guidance image as an AR virtual image Gi1 or a non-AR virtual image Gi2. The AR virtual image Gi1 is a virtual image Vi that presents information by associating the display position with the position of an object in the foreground. When the route guidance image is generated as an AR virtual image Gi1, the HCU 20 targets the road surface of the planned travel route in the foreground. As an example, as shown in FIG. 4, the AR virtual image Gi1 is generated as a plurality of objects having a three-dimensional shape arranged in a line from the current lane in which the vehicle A is traveling along the planned travel path. As a result, the AR virtual image Gi1 shows the planned route on the road surface. Even if the vehicle A moves, the AR virtual image Gi1 is displayed as being relatively fixed to a specific position on the road surface apparently for the occupant. The AR virtual image Gi1 is an example of a superposed virtual image.

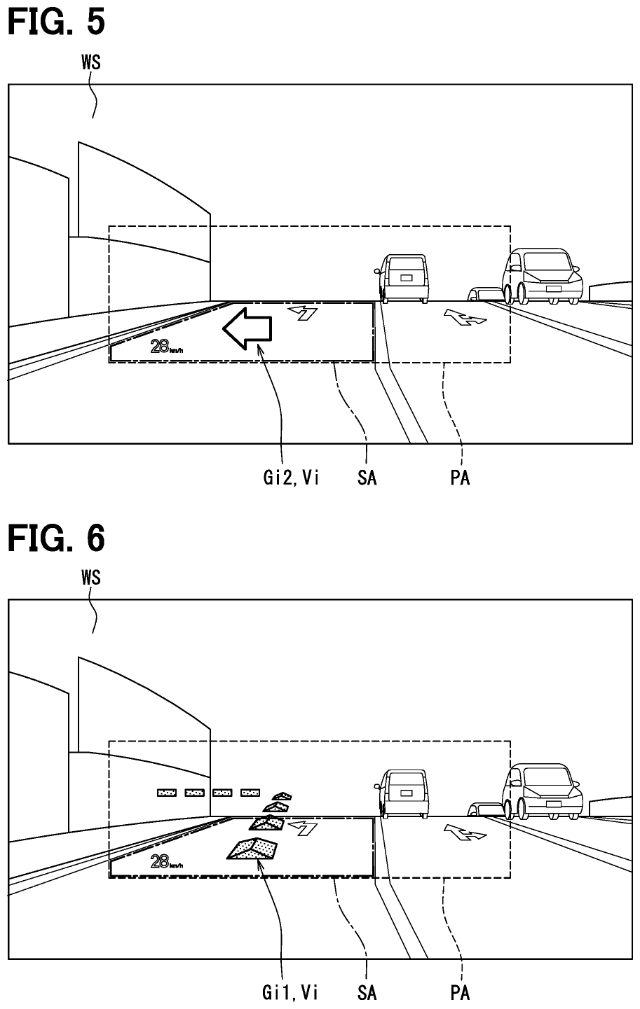

The non-AR virtual image Gi2 is a virtual image Vi that presents information without associating the display position with the position of the object. The non-AR virtual image Gi2 is not superimposed on a specific object in the foreground, but is simply superimposed on the foreground to indicate the planned travel path. As an example, as shown in FIG. 5, the non-AR virtual image Gi2 is generated as an arrow-shaped object indicating a turning direction when turning left or right at an intersection. The non-AR virtual image Gi2 is displayed as if it is relatively fixed to the vehicle configuration such as the front windshield WS. The AR virtual image Gi2 is an example of a non-superposed virtual image.

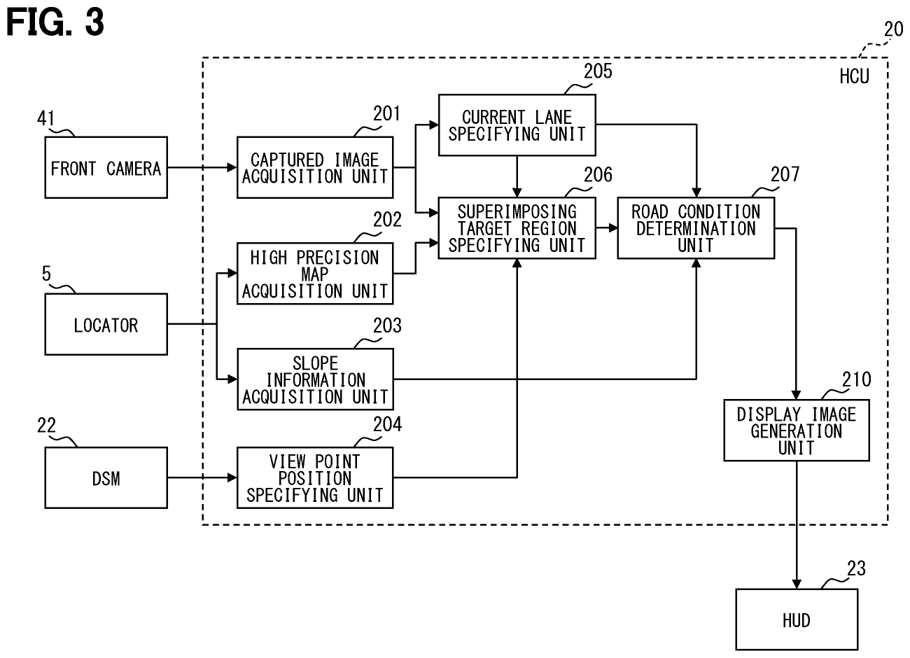

As shown in FIG. 3, the HCU 20 has an captured image acquisition unit 201, a high-precision map acquisition unit 202, a slope information acquisition unit 203, a viewpoint position specifying unit 204, and a current lane specifying unit 205, a superimposing target region specifying unit 206, a road condition determination unit 207, and a display image generation unit 210 as functional blocks relating to the generation of a route guidance image.

The captured image acquisition unit 201 acquires the captured image captured by the front camera 41. The high-precision map acquisition unit 202 acquires the information of the high-precision map around the current location of the vehicle A from the locator 5. The high-precision map acquisition unit 202 may be configured to acquire three-dimensional map data such as probe data from a server outside the vehicle A. The slope information acquisition unit 203 acquires information on the gradient of the road on which the vehicle A is traveling. For example, the slope information acquisition unit 203 acquires the slope information of the road stored in the high-precision map DB 52. Alternatively, the slope information acquisition unit 203 may acquire the gradient information based on the result of the image recognition processing of the captured image. Further, the slope information acquisition unit 203 may acquire gradient information by calculating the gradient of the road based on the information from the attitude sensor that detects the attitude of the vehicle A such as the inertial sensor 51. The slope information acquisition unit 203 acquires information regarding the downward slope in particular.

The viewpoint position specifying unit 204 specifies the viewpoint position of the driver based on the vehicle position of the own vehicle as a reference from the information of the viewpoint position sequentially detected by the DSM 22. For example, the viewpoint position specifying unit 204 converts the viewpoint position detected by the DSM 22 into the viewpoint position with the vehicle position of the own vehicle as a reference according to the difference between the position with the viewpoint position detected by the DSM 22 as a reference and the position with the vehicle position of the own vehicle as a reference, so that the unit 240 specifies the viewpoint position of the driver of the own vehicle.

The current lane specifying unit 205 specifies the current lane in which the vehicle A is traveling. The current lane specifying unit 205 may identify the current lane by image recognition processing of the acquired captured image. The current lane specifying unit 205 may specify the current lane by using map information such as navigation map data or high-precision map data. The information regarding the specified current lane is output to the road condition determination unit 207. If the current lane specifying unit 205 cannot specify the current lane, the current lane specifying unit 205 outputs information about not-specified to the road condition determination unit 207.

The superimposing target region specifying unit 206 specifies the superimposing target region SA of the AR virtual image Gi1 in the foreground. The superimposing target region SA is an area in the projection area PA on which the AR virtual image Gi1 is to be superimposed. In the case of the route guidance image, the superimposing target region SA is equivalent to the region where the object (disposed on the road surface of the planned traveling route) in the foreground exists in the projection region PA.

In order to specify the superimposing target region SA, the superimposing target region specifying unit 206 first extracts the road surface of the planned traveling route including the current lane from the objects captured in the captured image. For example, when the planned traveling route straddles a plurality of lanes, the superimposing target region specifying unit 206 extracts the road surfaces of the plurality of lanes. The superimposing target region specifying unit 206 detects a traveling lane marking line from, for example, an captured image, and detects a region between the traveling lane markings as a road surface. Alternatively, the superimposing target region specifying unit 206 may extract the road surface by image recognition processing such as semantic segmentation that classifies the captured objects for each pixel of the captured image. The superimposing target region specifying unit 206 may extract only a predetermined portion of the road surface of the planned traveling route in the foreground, such as the road surface of the road entering the intersection.

Further, when the road surface cannot be extracted from the captured image, the superimposing target region specifying unit 206 specifies the superimposing target region SA by using the acquired high-precision map data together. The superimposing target region specifying unit 206 extracts the road surface by combining the three-dimensional position information for each point of the road included in the high-precision map data with the information on the viewpoint position and the position of the projection area PA.

In addition, the superimposing target region specifying unit 206 specifies the region of the foreground area visually recognized from the viewpoint position of the occupant through the projection area PA based on the relative positional relationship between the installation position of the front camera 41, the position of the projection area PA, and the viewpoint position of the occupant.

The superimposing target region specifying unit 206 specifies the region occupied by the road surface in the scheduled travelling route as the superimposing target region SA in an foreground area visually recognized through the projection area PA from the viewpoint position of the occupant, based on the extraction result of the road surface in the captured image and the identification result of the area visually recognized through the projection area PA. In addition, the superimposing target region specifying unit 206 calculates the size of the area of the specified superimposing target region SA.

The road condition determination unit 207 determines the establishment of the road condition based on various information. The road condition is satisfied when the display position of the virtual image Vi can be associated with the position of the superimposing object in the foreground with respect to the road on which the vehicle A is traveling, and is not established when the display position of the virtual image Vi cannot be associated. The case where the display position of the virtual image Vi can be associated with the position of the object to be superposed in the foreground is the case where the virtual image Vi can be correctly superposed on the original superimposing target region SA when the virtual image Vi is displayed as the AR virtual image Gi1. The road condition determination unit 207 determines the establishment of a plurality of road conditions. More specifically, the road condition determination unit 207 determines whether or not the current lane can be specified, the area of the superimposing target region SA, and the presence or absence of a downward slope as road conditions.

The road condition determination unit 207 determines that the road condition is not satisfied when the current lane cannot be specified by the current lane specifying unit 205. The case where the current lane cannot be specified is, for example, the case where the recognition accuracy of the traveling lane is lower than the threshold value. If the current lane cannot be specified, the display position of the AR virtual image Gi1 may be shifted from the current lane. For example, in the case of a route guidance image, the planned travel route may be superimposed on a lane other than the current lane, so the road condition determination unit 207 determines that the road condition is not satisfied when the current lane cannot be specified.

When the area of the superimposing target region SA calculated by the superimposing target region specifying unit 206 is less than the threshold value, the road condition determination unit 207 determines that the road condition is not satisfied. When the area of the superimposing target region SA is less than the threshold value, there is not enough area in the projection area PA to superimpose the AR virtual image Gi1 on the object, and the display position of the AR virtual image Gi1 is not associated with the position of the superimposing object. Such a situation occurs when the traveling road has an uphill slope as shown in FIG. 6 or the curvature of the curve is large. In such a case, as shown in FIG. 6, since the AR virtual image Gi1 can be displayed as if it floats on the road surface, the road condition determination unit 207 determines that the road condition is not satisfied when the area of the superimposing target region SA is less than the threshold value.

The threshold value is a value predetermined according to the size of the display range of the AR virtual image Gi1 to be generated. In the case of the first embodiment, the display range of the AR virtual image Gi1 is the display range of the whole of the plurality of objects exhibiting a three-dimensional shape. The display range can be defined as the display size. In particular, the smaller the size of the vertical display range of the AR virtual image Gi1, the smaller the threshold value. That is, in the case of the AR virtual image Gi1 whose display range may be small, the road condition determination unit 207 gives priority to the display as the AR virtual image Gi1 even if the superimposing target region SA is relatively small.

The road condition determination unit 207 determines that the road condition is not satisfied when the road has a downward slope. When the road is a downward slope, the vehicle A is in a state where the front side is lowered. If the AR virtual image Gi1 is superimposed on the road surface in this state, it may be superimposed on a position lower than the original road surface position, and may be displayed as if the image is sunk with respect to the road surface, so that the road condition determination unit 207 determines the road condition is not established when the road is downhill.

The display generation unit 210 generates a route guidance image in a display mode according to the determination result of the road condition. That is, the display generation unit 210 generates a route guidance image as an AR virtual image Gi1 when it is determined that the road condition is satisfied, and when it is determined that the road condition is not satisfied, the display generation unit 210 generates the route guidance image as a non-AR virtual image Gi1.

When generating the AR virtual image Gi1, the display generation unit 210 specifies the relative position of the road surface with respect to the vehicle A based on the position coordinates of the road surface and the position coordinates of the own vehicle. The display generation unit 210 may specify the relative position by using the two-dimensional position information of the navigation map data, or specify the relative position by using the three-dimensional position information when the high-precision map data is available. The display generation unit 210 determines the projection position and projection shape of the AR virtual image Gi1 by geometric calculation based on the relationship between the specified relative position, the viewpoint position of the occupant acquired from the DSM22, and the position of the projection area PA.

In the generation of the AR virtual image Gi1, the display generation unit 210 changes the mode of the superimposed display when the AR virtual image Gi1 is superimposed on the traffic light. Whether or not the AR virtual image Gi1 is superimposed on the traffic light is determined based on, for example, the relationship between the position information of the traffic light identified by the image recognition process on the acquired captured image and the determined display position of the AR virtual image Gi1. The display generation unit 210 changes the mode of superimposed display by, for example, correcting the display position of the AR virtual image Gi1 to a position that does not superimpose on the traffic light. Alternatively, the display generation unit 210 may change the superimposing display mode so as to improve the visibility of the traffic light on which the AR virtual image Gi1 is superimposed, by, for example, lowering the brightness of the AR virtual image Gi1, increasing the transparency, and displaying only a part of the outline or the like.

When generating the non-AR virtual image Gi2, the display generation unit 210 sets a preset position in the projection area PA as the display position. The display generation unit 210 outputs the data of the generated AR virtual image Gi1 or non-AR virtual image Gi2 to the HUD23, projects the image on the front windshield WS, and presents the planned route information to the occupant.

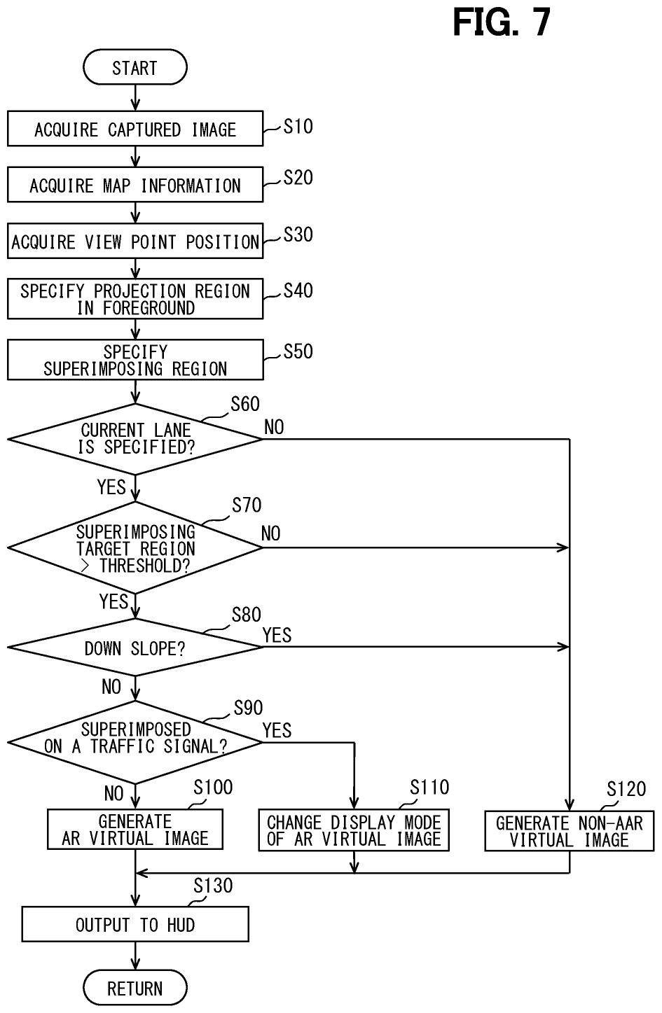

Next, an example of the processing executed by the HCU 20 will be described with reference to the flowchart of FIG. 7. The HCU 20 executes the process shown in FIG. 7 when the vehicle A reaches the display section of the route guidance image.

The HCU 20 first acquires a captured image in step S10. In step S20, if there is high-precision map data, the high-precision map data is acquired. In step S30, the viewpoint position is acquired from the DSM22. In step S40, the projection area PA in the foreground captured in the captured image is specified based on the acquired viewpoint position, the installation position of the front camera 41, and the position of the projection area PA. In step S50, the road surface which is the object to be superimposed is detected, and the superimposing target region SA to be superimposed in the projected area in the specified foreground is specified.

In step S60, it is determined whether or not the current lane can be specified based on the acquired captured image. If it is determined that the current lane cannot be specified, the process proceeds to step S120, and a non-AR virtual image Gi2 is generated as a route guidance image. On the other hand, if it is determined in step S50 that the current lane can be specified, the process proceeds to step S60. In step S60, the superimposing target region SA of the AR virtual image Gi1 is specified based on the captured image. In step S70, it is determined whether or not the area of the specified superimposing target region SA exceeds the threshold value. If it is determined that the threshold value is lower than the threshold value, the process proceeds to step S120.

On the other hand, if it is determined that the threshold value is exceeded, the process proceeds to step S80, and it is determined whether or not the traveling road has a downward slope. Whether or not it is a downward gradient is determined, for example, by determining whether or not the threshold value of the gradient exceeds a preset threshold value. If it is determined that the slope is downward, the process proceeds to step S120.

If it is determined in step S80 that the slope is not downward, the process proceeds to step S90. In step S90, the display position of the AR virtual image Gi1 is determined, and it is determined whether or not the AR virtual image Gi1 is superimposed on the traffic light. If it is determined that the signal is not superimposed on the traffic light, the process proceeds to step S100 to generate an AR virtual image Gi1. When it is determined that the image is superimposed on the traffic light, an AR virtual image Gi1 having a modified display mode is generated.

When the virtual image Vi is generated in steps S100, S110 and S120, the process proceeds to step S130, and the generated virtual image Vi data is output to the HUD. When the process of step S130 is performed, the process returns to step S10 again. The HCU 20 repeats a series of processes until the vehicle A passes through the display section of the route guidance image.

Next, the configuration and the operation and effect of the HCU 20 of the first embodiment will be described.

The HCU 20 has a road condition determination unit 207 that determines whether or not a road condition that can associate the display position of the virtual image Vi with the position of the road surface in the foreground is satisfied with respect to the road on which the vehicle A travels. The HCU 20 includes a display generation unit 210. When the road condition is satisfied, the display generation unit 210 generates a virtual image Vi as an AR virtual image Gi1 that presents a planned travel route by associating the display position with the position of the road surface. The display generation unit 210 includes a display generation unit 210 that generates as a non-AR virtual image Gi2 that presents a planned travel route without associating the display position with the position of the road surface when the road condition is not satisfied.

According to this, when the road condition is not satisfied, the HCU 20 presents the information to the occupant by the non-AR virtual image Gi2 instead of the AR virtual image Gi1. Therefore, when it is difficult to relate the display position of the AR virtual image Gi1 to the position of the object in the foreground, the information can be presented without associating the display position. As a result, the HCU 20 can present the same information to the occupant regardless of the display position. As described above, it is possible to provide the HCU 20 and a display control program capable of suppressing erroneous recognition of information presented by a virtual image Vi.

The HCU 20 determines that the road condition is unsuccessful when the road is at least one of a curved road and a sloped road. According to this, when the shape of the road on which the vehicle is traveling has a shape that makes it impossible to associate the display position of the virtual image Vi, the HCU 20 determines that the road condition is not satisfied and performs the information presentation by the non-AR virtual image Gi2. As described above, the HCU 20 can present information in a display mode according to the shape of the road on which the vehicle is traveling, and can suppress erroneous recognition of the information.

The HCU 20 includes a superimposing target region specifying unit 206 that specifies the superimposing target region SA of the AR virtual image Gi1 in the foreground. The road condition determination unit 207 determines whether or not the road condition is satisfied based on the specified superposing target region SA. According to this, since the HCU 20 determines whether to display the AR virtual image Gi1 or the non-AR virtual image Gi2 based on the specified superimposing target region SA, it is possible to determine more accurately whether the display position of the AR virtual image Gi1 can be associated with the position of the object.

The HCU 20 identifies the superimposing target region SA based on the road surface detection information by the front camera 41. According to this, the HCU 20 can specify the superimposing target region SA in the foreground during actual traveling without being affected by aging.

When it is impossible to specify the superimposing target region SA based on the image captured by the front camera 41, the HCU 20 specifies the superimposing target region SA by using the high-precision map data together. According to this, the HCU 20 can more accurately specify the superimposing target region SA even when it is impossible to specify the superimposing target region SA only by the captured image.

The HCU 20 changes the threshold value of the area of the superimposing target region SA to be smaller as the display size of the generated AR virtual image Gi1 is smaller. Therefore, the HCU 20 can determine the road condition according to the display size of the AR virtual image Gi1.

The HCU 20 determines that the road condition is not established when the road has a downward slope. In the case of a downward slope, displaying the AR virtual image Gi1 may result in a superimposed display as if the image is sunk with respect to the road surface. Therefore, in the case of a downward slope, this can be avoided by setting the non-AR virtual image Gi2. In particular, the HCU 20 of the first embodiment determines whether or not the road is a downward slope in addition to determining whether or not the superposing target region SA exceeds the threshold value. Therefore, the HCU 20 can switch between the AR virtual image Gi1 and the non-AR virtual image Gi2 according to a condition that causes a downward shift of the AR virtual image Gi1 that cannot be determined only by determining the area of the superimposing target region SA.

The HCU 20 determines that the road condition is not satisfied when the current lane cannot be specified at present. If the current lane cannot be specified, it becomes difficult to determine the display position of the AR virtual image Gi1. In such a case, since the non-AR virtual image Gi2 can be set, the display deviation of the AR virtual image Gi1 can be avoided.

When the AR virtual image Gi1 is superimposed on the traffic light, the HCU 20 changes the display mode of the AR virtual image Gi1. According to this, the HCU 20 can avoid that the AR virtual image Gi1 is superimposed on the traffic light and the visibility of the traffic light is lowered due to the change of the display mode.

### Other Embodiments

The present disclosure in the present specification is not limited to the illustrated embodiments. The present disclosure encompasses the illustrated embodiments and modifications based on the embodiments by those skilled in the art. For example, the present disclosure is not limited to the combinations of components and/or elements shown in the embodiments. The present disclosure may be implemented in various combinations. The present disclosure may have additional portions that may be added to the embodiments. The present disclosure encompasses omission of components and/or elements of the embodiments. The present disclosure encompasses the replacement or combination of components and/or elements between one embodiment and another. The disclosed technical scope is not limited to the description of the embodiments. The several technical scopes disclosed are indicated by the description of the claims, and should be construed to include all modifications within the meaning and scope equivalent to the description of the claims.

In the above-described embodiment, the HCU 20 switches between the AR virtual image Gi1 and the non-AR virtual image Gi2 based on the determination result of the road condition. Instead of this, the HCU 20 may be configured to change a part of the AR virtual image Gi1 to be a non-AR virtual image Gi2 when the road conditions are not satisfied. In this case, the HCU 20 may set the portion of the AR virtual image Gi1 in which the display position cannot be associated with the position of the object, for example, that is the portion outside the superimposing target region SA as the non-AR virtual image Gi2.

In the above-described embodiment, the HCU 20 is configured to determine whether or not it is satisfied for a plurality of road conditions. Instead, the HCU 20 may determine whether or not at least one of the road conditions is satisfied, and determine whether to generate the AR virtual image Gi1 or the non-AR virtual image Gi2 based on the determination result.

In the above-described embodiment, the HCU 20 determines the superimposing target region SA based on the image data of the front camera 41. Instead, the HCU 20 may specify the superimposing target region SA based on the detection information of another peripheral monitoring sensor 4 such as LIDAR.

In the above-described embodiment, the HCU 20 determines whether or not the road has an uphill slope based on whether or not the area of the superimposing target region SA exceeds the threshold value. Instead, the HCU 20 may determine whether or not the road has an uphill slope based on the magnitude of the slope calculated from map information, detection information of the attitude sensor, and the like. Similarly, the HCU 20 may determine whether or not the road is a curved road based on the magnitude of the curve curvature.

In the above-described embodiment, the HCU 20 determines that the switching control of the generation of the AR virtual image Gi1 and the non-AR virtual image Gi2 based on the road condition is performed for the route guidance image. The HCU 20 may perform switching control not only for the route guidance image but also for the virtual image Vi that presents various information. For example, the HCU 20 may perform the above-mentioned switching control for displaying an image showing a stop line, an image emphasizing a preceding vehicle, an image prompting lane keeping, and the like.

The processor according to the embodiment described above is a processing unit including one or more CPUs (Central Processing Units). In addition to the CPUs, the processor described above may be a processor including a GPU (Graphics Processing Unit), a DFP (Data Flow Processor), and the like. Further, the processor may be a processing unit including an FPGA (Field-Programmable Gate Array), an IP core specialized for a particular processing such as learning and reasoning of AI, and so on. The arithmetic circuit units of the processor described above may be individually mounted on a printed circuit board, or may be mounted on an ASIC (Application Specific Integrated Circuit), an FPGA, or the like.

Various non-transitory tangible storage media (non-transitory tangible storage medium) such as a flash memory and a hard disk can be employed as the memory device for storing the display control programs. The form of such a storage medium may be appropriately changed. For example, the storage medium may be in the form of a memory card or the like, and may be inserted into a slot portion provided in the in-vehicle ECU and electrically connected to the control circuit.

The control unit and the method described in the present disclosure may be implemented by a special purpose computer configuring a processor programmed to perform one or more functions embodied by a computer program. Alternatively, the device and the method described in the present disclosure may be implemented by a dedicated hardware logic circuit. Alternatively, the device and the method described in the present disclosure may be implemented by one or more dedicated computers configured by a combination of a processor executing a computer program and one or more hardware logic circuits. The computer programs may be stored, as instructions to be executed by a computer, in a tangible non-transitory computer-readable storage medium.

Here, the process of the flowchart or the flowchart described in this application includes a plurality of sections (or steps), and each section is expressed as, for example, S10. Further, each section may be divided into several subsections, while several sections may be combined into one section. Furthermore, each section thus configured may be referred to as a device, module, or means.

Although the present disclosure has been described in accordance with the examples, it is to be understood that the disclosure is not limited to such examples or structures. The present disclosure also encompasses various modifications and variations within an equivalent range. In addition, various combinations and forms, and other combinations and forms including only one element, more, or less than them are also included in the scope and concept of the present disclosure.

The controllers and methods described in the present disclosure may be implemented by a special purpose computer created by configuring a memory and a processor programmed to execute one or more particular functions embodied in computer programs. Alternatively, the controllers and methods described in the present disclosure may be implemented by a special purpose computer created by configuring a processor provided by one or more special purpose hardware logic circuits. Alternatively, the controllers and methods described in the present disclosure may be implemented by one or more special purpose computers created by configuring a combination of a memory and a processor programmed to execute one or more particular functions and a processor provided by one or more hardware logic circuits. The computer programs may be stored, as instructions being executed by a computer, in a tangible non-transitory computer-readable medium.

It is noted that a flowchart or the processing of the flowchart in the present application includes sections (also referred to as steps), each of which is represented, for instance, as S10. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A display control device for a vehicle that controls displaying a virtual image superimposed on a foreground scenery of an occupant, the display control device comprising:
a road condition determination unit that determines whether a road condition, for associating a display position of the virtual image with a position of an object in the foreground scenery with respect to a road on which the vehicle travels, is satisfied; and
a display image generation unit that generates the virtual image as a superposing virtual image that presents information by associating the display position with the position of the object when the road condition is satisfied, and generates at least a part of the virtual image as a non-superimposing virtual image that presents the information without associating the display position with the position of the object when the road condition is not satisfied.

2. The display control device according to claim 1, wherein:
the road condition determination unit determines that the road condition is not satisfied when the road is at least one of a curved road and a slope road.

3. The display control device according to claim 1, further comprising:
a superimposing target region specifying unit that specifies a superimposing target region of a superimposing virtual image in the foreground scenery, wherein:
the road condition determination unit determines whether the road condition is satisfied, based on a specific result of the superimposing target region specifying unit.

4. The display control device according to claim 3, wherein:
the superimposing target region specifying unit specifies the superimposing target region based on a detection information of the foreground scenery by an in-vehicle sensor.

5. The display control device according to claim 4, wherein:
the superimposing target region specifying unit specifies the superimposing target region based on three-dimensional map information when the superimposing target region is not specified based on the detection information.

6. The display control device according to claim 3, wherein:
the road condition determination unit determines that the road condition is not satisfied when an area of the superimposing target region in a projection area (PA) on which the virtual image is projected is less than a threshold value.

7. The display control device according to claim 6, wherein:
the road condition determination unit sets the threshold value smaller as a display size of the superimposing virtual image is smaller.

8. The display control device according to claim 6, wherein:
the road condition determination unit determines that the road condition is not satisfied when the road has a downward slope.

9. The display control device according to claim 1, wherein:
the road condition determination unit determines that the road condition is not satisfied when a current lane in which the vehicle travels is specified.

10. The display control device according to claim 1, wherein:
the display generation unit changes a display mode of the superposing virtual image when the superposing virtual image is superposed on a traffic light.

11. The display control device according to claim 1, further comprising:
one or more processors; and
a memory coupled to the one or more processors and storing program instructions that when executed by the one or more processors cause the one or more processors to provide at least: the road condition determination unit and the display image generation unit.

12. A display control method for a vehicle that controls displaying a virtual image to be superimposed on a foreground scenery of an occupant, the display control method comprising:
determining whether a road condition, for associating a display position of the virtual image with a position of an object in the foreground scenery with respect to a road on which the vehicle travels, is satisfied;
generating the virtual image as a superposing virtual image that presents information by associating the display position with the position of the object when the road condition is satisfied; and
generating at least a part of the virtual image as a non-superimposing virtual image that presents the information without associating the display position with the position of the object when the road condition is not satisfied.

13. A non-transitory tangible computer-readable storage medium that includes instructions executed by a computer, the instructions for a vehicle to control displaying a virtual image superimposed on a foreground scenery of an occupant, the instructions comprising:
determining whether a road condition, for associating a display position of the virtual image with a position of an object in the foreground scenery with respect to a road on which the vehicle travels, is satisfied; and
generating the virtual image as a superposing virtual image that presents information by associating the display position with the position of the object when the road condition is satisfied; and
generating at least a part of the virtual image as a non-superimposing virtual image that presents the information without associating the display position with the position of the object when the road condition is not satisfied.
